(19) United States
(12) Patent Application Publication
(10) Pub. No.: US 2026/0001481 A1
(43) Pub. Date: Jan. 1, 2026

(54) DRIVE ASSIST APPARATUS FOR VEHICLE

(71) Applicant: SUBARU CORPORATION, Tokyo (JP)

(72) Inventors: Akito ITO, Tokyo (JP); Toyohiro HARA, Tokyo (JP)

(21) Appl. No.: 19/228,874

(22) Filed: Jun. 5, 2025

(30) Foreign Application Priority Data
Jun. 26, 2024 (JP) 2024-102846

(51) Int. Cl. B60Q 9/00

(52) U.S. Cl. CPC B60Q 9/00

(57) ABSTRACT

A drive assist apparatus for a vehicle includes a traveling environment recognizer, a monitor, a steering guide, and a blinking controller. The traveling environment recognizer is configured to recognize traveling environment information outside the vehicle. The monitor is configured to monitor a line of sight of a driver who drives the vehicle. The steering guide is configured to give guidance, based on the traveling environment information, on steering that involves blinking of a direction indicator of the vehicle. The blinking controller is configured to automatically blink the direction indicator when determination is made that before a set period elapses after the guidance on the steering, the driver has viewed a check region where a safety check is necessary for the steering.

The present application claims priority from Japanese Patent Application No. 2024-102846 filed on June 26, 2024, the entire contents of which are hereby incorporated by reference.

### BACKGROUND

The disclosure relates to a drive assist apparatus that is to be applied to a vehicle and performs a drive assist during traveling involving steering, such as changing lanes or turning right or left.

In recent years, many vehicles such as automobiles include drive assist apparatuses. The drive assist apparatus basically realizes drive assist control with an adaptive cruise control (ACC) function, an active lane keep centering (ALKC) control function, and the like. By such drive assist control, the drive assist apparatus realizes reduction in a burden on a driving operation of a driver who drives the vehicle, improvement in safety during traveling, and the like.

Various technologies have been proposed for the purpose of, for example, further improving the convenience of the drive assist apparatus. For example, Japanese Unexamined Patent Application Publication (JP-A) No. 2001-18708 discloses a technology of automatically turning ON a direction indicator to indicate a direction intended by a driver when a driver's deceleration operation is detected behind or near an intersection and detection is made that a vehicle is traveling near the right or left side of a road.

### SUMMARY

An aspect of the disclosure provides a drive assist apparatus for a vehicle. The drive assist apparatus includes a traveling environment recognizer, a monitor, a steering guide, and a blinking controller. The traveling environment recognizer is configured to recognize traveling environment information outside the vehicle. The monitor is configured to monitor a line of sight of a driver who drives the vehicle. The steering guide is configured to give guidance, based on the traveling environment information, on steering that involves blinking of a direction indicator of the vehicle. The blinking controller is configured to automatically blink the direction indicator when determination is made that before a set period elapses after the guidance on the steering, the driver has viewed a check region where a safety check is necessary for the steering.

An aspect of the disclosure provides a drive assist apparatus for a vehicle. The drive assist apparatus includes a traveling environment recognition unit, a monitoring unit, and a processor. The traveling environment recognition unit is configured to recognize traveling environment information outside the vehicle. The monitoring unit is configured to monitor a line of sight of a driver who drives the vehicle. The processor is configured to give guidance, based on the traveling environment information, on steering that involves blinking of a direction indicator of the vehicle. The processor is configured to automatically blink the direction indicator when determination is made that before a set period elapses after the guidance on the steering, the driver has viewed a check region where a safety check is necessary for the steering.

### BRIEF DESCRIPTION OF THE DRAWINGS

The accompanying drawings are included to provide a further understanding of the disclosure and are incorporated in and constitute a part of this specification. The drawings illustrate an embodimentcccc and, together with the specification, serve to describe the principles of the disclosure.

FIG. 1 is an overall configuration diagram illustrating a drive assist apparatus for a vehicle;

FIG. 2 is an explanatory diagram illustrating check regions when a direction indicator is blinked;

FIG. 3 is a flowchart (part 1) illustrating a blinking control routine on the direction indicator for a lane change;

FIG. 4 is a flowchart (part 2) illustrating the blinking control routine on the direction indicator for the lane change;

FIG. 5 is a flowchart (part 1) illustrating a blinking control routine on the direction indicator for a right or left turn;

FIG. 6 is a flowchart (part 2) illustrating the blinking control routine on the direction indicator for the right or left turn;

FIG. 7 is a diagram illustrating a relationship between a view timing and an evaluation point for each check region; and

FIG. 8 is a diagram illustrating a relationship between a view timing and an evaluation point for each check region.

### DETAILED DESCRIPTION

The technology disclosed in JP-A No. 2001-18708 is mainly a technology of automatically turning ON the direction indicator based on the traveling state of the vehicle. Therefore, in the technology disclosed in JP-A No. 2001-18708, there is a possibility that the direction indicator is automatically turned ON without consideration of safety for surrounding vehicles and the like.

It is desirable to provide a drive assist apparatus that is to be applied to a vehicle and can automatically turn ON a direction indicator while ensuring safety and convenience for a driver.

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

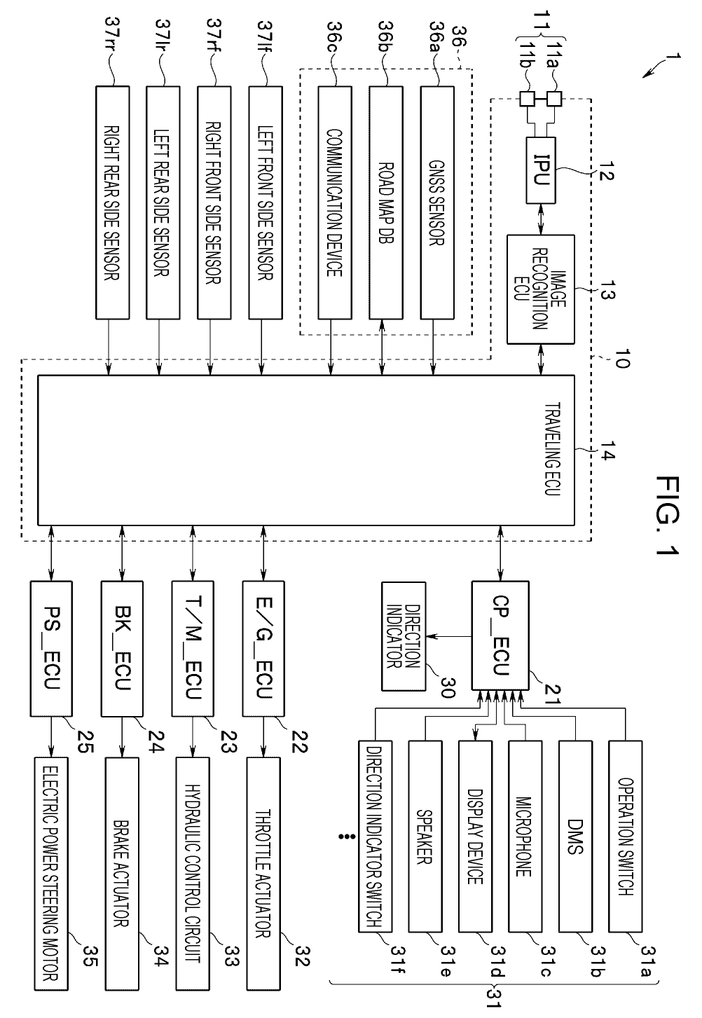

As illustrated in FIG. 1, a drive assist apparatus 1 includes a camera unit 10. The camera unit 10 is fixed to, for example, a center of a front and upper portion of a cabin of a vehicle M.

The camera unit 10 includes a stereo camera 11, an image processing unit (IPU) 12, an image recognition unit (image recognition ECU) 13, and a traveling control unit (traveling ECU) 14.

The stereo camera 11 includes a main camera 11a and a subcamera 11b. The main camera 11a and the subcamera 11b each include, for example, an imaging device such as a CMOS. The main camera 11a and the subcamera 11b are disposed at bilaterally symmetrical positions across the center of the vehicle M in a vehicle width direction.

The main camera 11a and the subcamera 11b perform stereo imaging of a traveling environment ahead of the vehicle from different viewpoints. The imaging cycles of the main camera 11a and the subcamera 11b are synchronized with each other.

The IPU 12 performs predetermined image processing on the traveling environment image captured by the stereo camera 11. Thus, the IPU 12 detects edges of various targets such as a three dimensional object and a marking line on a road surface which are represented in the image. Then, the IPU 12 determines distance information from a positional deviation amount of the corresponding edges in the right and left images. Thus, the IPU 12 generates image information (distance image information) including the distance information.

The image recognition ECU 13 determines a road curvature [1/M] between marking lines that demarcate the right and left of a lane where the vehicle M is traveling (vehicle traveling road), and a width between the right and left marking lines (lane width) based on, for example, the distance image information received from the IPU 12. The image recognition ECU 13 also determines a road curvature between marking lines that demarcate the right and left of a lane or the like adjacent to the lane where the vehicle M is traveling, and a width between the right and left marking lines.

The image recognition ECU 13 performs, for example, predetermined pattern matching on the distance image information. Thus, the image recognition ECU 13 recognizes three-dimensional objects along the road, such as guardrails, curbs, median strips, and surrounding vehicles. In the recognition of three-dimensional objects, the image recognition ECU 13 also recognizes supplementary information such as types of the three-dimensional objects, distances to the three-dimensional objects, speeds of the three-dimensional objects, and relative speeds between the three-dimensional objects and the vehicle M.

Then, the image recognition ECU 13 outputs various kinds of recognized information to the traveling ECU 14 as traveling environment information.

As described above, in the present embodiment, the image recognition ECU 13 together with the stereo camera 11 and the IPU 12 correspond to a specific example of a traveling environment recognizer (traveling environment recognition unit) that recognizes the traveling environment information outside the vehicle.

The traveling ECU 14 is a control unit that centrally controls the drive assist apparatus 1.

As various control units, a cockpit control unit (CP_ECU) 21, an engine control unit (E/G_ECU) 22, a transmission control unit (T/M_ECU) 23, a brake control unit (BK_ECU) 24, and a power steering control unit (PS_ECU) 25 are coupled to the traveling ECU 14 via an in-vehicle communication line such as a controller area network (CAN).

In addition, a locator unit 36, a left front side sensor 37lf, a right front side sensor 37rf, a left rear side sensor 37lr, and a right rear side sensor 37rr are coupled to the traveling ECU 14 as various sensors.

A human-machine interface (HMI) 31 disposed around a driver's seat is coupled to the CP_ECU 21. The HMI 31 includes, for example, an operation switch 31a, a driver monitoring system (DMS) 31b, a microphone 31c, a display device 31d, a speaker 31e, and a direction indicator switch 31f.

The operation switch 31a is a switch for performing switching between driving modes, making various settings on and executing drive assist control, and the like.

In the present embodiment, the DMS 31b corresponds to a specific example of a monitor (monitoring unit). This DMS 31b performs face authentication for the driver. Further, the DMS 31b can monitor the line of sight, facial expression, or the like of the driver who has undergone the face authentication.

The microphone 31c collects voice and sound in the cabin. Thus, the microphone 31c detects voice and sound uttered by, for example, the driver.

The display device 31d notifies, for example, the driver about various kinds of information on drive assist control and the like by display. The display device 31d is desirably, for example, a touch panel display on which an input operation can be performed by, for example, the driver.

The speaker 31e notifies, for example, the driver about various kinds of information on drive assist control and or like by voice and sound.

The direction indicator switch 31f is a switch for causing a direction indicator 30 of the vehicle M to perform a blinking operation in response to an operation input by the driver.

When a control signal is received from the traveling ECU 14, the CP_ECU 21 notifies the driver as appropriate about various kinds of information on various alerts for preceding vehicles and the like, the execution status of the drive assist control, and the traveling environment or the like for the vehicle M. Such notification is performed by display using the display device 31d, audio output using the speaker 31e, and the like.

The CP_ECU 21 outputs, to the traveling ECU 14, various kinds of input information input by the driver using the operation switch 31a or the like. For example, the CP_ECU 21 outputs various kinds of input information such as an ON or OFF operation state for various kinds of drive assist control, a vehicle speed Vs set for the vehicle M (set vehicle speed), and an operation state of the direction indicator switch 31f to the traveling ECU 14.

Further, the CP_ECU 21 performs automatic blinking control on the direction indicator 30 of the vehicle M. For example, the CP_ECU 21 determines whether to automatically blink the direction indicator 30 for a right turn or a left turn based on information on the line of sight of the driver detected by the DMS 31b. When determination is made to automatically blink the direction indicator 30, the CP_ECU 21 automatically blinks the direction indicator 30. Further, the CP_ECU 21 outputs, to the traveling ECU 14, a determination result indicating that the direction indicator 30 is to be automatically blinked. The automatic blinking control on the direction indicator 30 by the CP_ECU 21 will be described in detail later.

A throttle actuator 32 or the like of an electronically controlled throttle is coupled to an output side of the E/G_ECU 22. Various sensors such as an accelerator sensor (not illustrated) are coupled to an input side of the E/G_ECU 22.

The E/G_ECU 22 controls drive of the throttle actuator 32 based on a control signal from the traveling ECU 14, detection signals from various sensors, or the like. Thus, the E/G_ECU 22 adjusts the intake air amount of an engine to generate a desired engine output. The E/G_ECU 22 outputs signals on an accelerator operation amount and the like detected by various sensors to the traveling ECU 14.

A hydraulic control circuit 33 is coupled to an output side of the T/M_ECU 23. Various sensors such as a shift position sensor (not illustrated) are coupled to an input side of the T/M_ECU 23. The T/M_ECU 23 performs hydraulic control on the hydraulic control circuit 33 based on a signal on an engine torque estimated by the E/G_ECU 22, detection signals from various sensors, and the like. Thus, the T/M_ECU 23 operates frictional engagement elements, pulleys, and the like provided in an automatic transmission to change the engine output at a desired speed ratio. The T/M_ECU 23 outputs signals on a shift position or the like detected by various sensors to the traveling ECU 14.

A brake actuator 34 is coupled to an output side of the BK_ECU 24. The brake actuator 34 adjusts a brake fluid pressure to be output to a brake wheel cylinder provided to each wheel. Various sensors (not illustrated) such as a brake pedal sensor, a yaw rate sensor, a longitudinal accelerator sensor, and a vehicle speed sensor are coupled to an input side of the BK_ECU 24.

The BK_ECU 24 controls drive of the brake actuator 34 based on a control signal from the traveling ECU 14 or detection signals from various sensors. Thus, the BK_ECU 24 causes the wheels to generate braking forces as appropriate to perform forced braking control, yaw rate control, and the like on the vehicle M. The BK_ECU 24 outputs signals on a brake operation state, a yaw rate, a longitudinal acceleration, a vehicle speed, and the like detected by various sensors to the traveling ECU 14.

An electric power steering motor 35 is coupled to an output side of the PS_ECU 25. The electric power steering motor 35 applies a steering torque generated by a rotational force of a motor to a steering mechanism. Various sensors such as a steering torque sensor and a steering angle sensor are coupled to an input side of the PS_ECU 25.

The PS_ECU 25 controls drive of the electric power steering motor 35 based on a control signal from the traveling ECU 14 or detection signals from various sensors. Thus, the PS_ECU 25 generates a steering torque for the steering mechanism. The PS_ECU 25 outputs signals on the steering torque, the steering angle, and the like detected by various sensors to the traveling ECU 14.

The locator unit 36 includes a GNSS sensor 36a, a high-precision road map database (road map DB) 36b, and a communication device 36c.

The GNSS sensor 36a receives positioning signals transmitted from a plurality of positioning satellites. Thus, the GNSS sensor 36a measures the position (latitude, longitude, altitude, etc.) of the vehicle M.

The road map DB 36b is a mass storage medium such as an HDD. High-precision road map information (dynamic map) is stored in the road map DB 36b. The road map information includes, for example, lane width data, lane center position coordinate data, traveling azimuth angle data of lanes, and speed limit data, as lane data for use in autonomous driving. The lane data includes pieces of data stored for several-meter intervals in each lane on the road map. For example, the road map DB 36b outputs road map information in a set range based on the vehicle position measured by the GNSS sensor 36a to the traveling ECU 14 as the traveling environment information based on a request signal from the traveling ECU 14.

The communication device 36c receives various kinds of traffic information transmitted from, for example, a vehicle information communication system (VICS (registered trademark)) by road-to-vehicle communication. The communication device 36c can also receive various kinds of traffic information transmitted from, for example, surrounding vehicles by vehicle-to-vehicle communication. The traffic information received by the communication device 36c includes, for example, traffic jam information and road regulation information provided due to accidents, weather, and the like.

As described above, in the present embodiment, the road map DB 36b together with the GNSS sensor 36a and the communication device 36c correspond to a specific example of the traveling environment recognizer (traveling environment recognition unit) that recognizes the traveling environment information outside the vehicle.

Each of the left front side sensor 37lf and the right front side sensor 37rf is, for example, a millimeter wave radar. The left front side sensor 37lf and the right front side sensor 37rf are disposed, for example, on the left and right sides of a front bumper, respectively. The left front side sensor 37lf and the right front side sensor 37rf detect, as the traveling environment information, three-dimensional objects in left and right obliquely forward and side areas around the vehicle M that are difficult to recognize from an image captured by the stereo camera 11.

Each of the left rear side sensor 37lr and the right rear side sensor 37rr is, for example, a millimeter wave radar. The left rear side sensor 37lr and the right rear side sensor 37rr are disposed, for example, on the left and right sides of a rear bumper, respectively. The left rear side sensor 37lr and the right rear side sensor 37rr detect, as the traveling environment information, three-dimensional objects in left and right obliquely rearward and side areas around the vehicle M that are difficult to recognize by the left front side sensor 37lf and the right front side sensor 37rf.

When each radar is a millimeter wave radar, the millimeter wave radar mainly detects three-dimensional objects such as a vehicle traveling side by side and a succeeding vehicle by outputting radio waves and analyzing the reflected waves from the objects. Specifically, each radar detects a lateral width of the three-dimensional object, a position of a representative point of the three-dimensional object (relative position to the vehicle M), and a speed, as the information on the three-dimensional object.

As described above, in the present embodiment, the left front side sensor 37lf, the right front side sensor 37rf, the left rear side sensor 37lr, and the right rear side sensor 37rr correspond to specific examples of the traveling environment recognizer (traveling environment recognition unit) that recognizes the traveling environment information outside the vehicle.

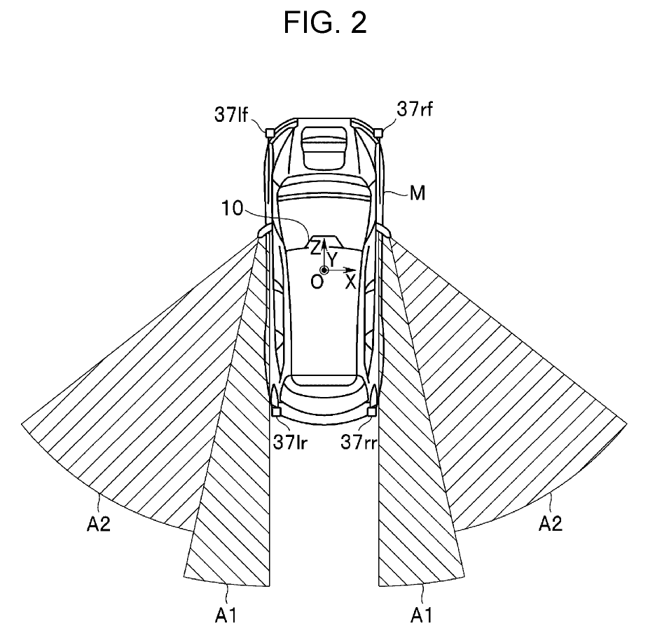

Coordinates of the external targets in the traveling environment information recognized by the image recognition ECU 13, the locator unit 36, the left front side sensor 37lf, the right front side sensor 37rf, the left rear side sensor 37lr, and the right rear side sensor 37rr are converted by the traveling ECU 14 into, for example, coordinates in a three-dimensional coordinate system (see FIG. 2) having its origin at the center of the vehicle M.

The traveling ECU 14 may set driving modes such as a manual driving mode, a first traveling control mode, a second traveling control mode, and a limp home mode. The traveling ECU 14 can selectively switch between the driving modes based on, for example, an operation status of the operation switch 31a.

The manual driving mode is a driving mode in which the driver needs to hold the steering wheel. That is, the manual driving mode is a driving mode in which the vehicle M travels by driving operations of the driver, such as a steering operation, an accelerator operation, and a brake operation.

Similarly, the first traveling control mode is a driving mode in which the driver needs to hold the steering wheel. That is, the first traveling control mode is a so-called semi-autonomous driving mode in which the vehicle M travels while reflecting the driving operations of the driver. The first traveling control mode is realized by, for example, outputting various control signals to the E/G_ECU 22, the BK_ECU 24, and the PS_ECU 25 from the traveling ECU 14. In the first traveling control mode, adaptive cruise control (ACC), active lane keep centering (ALKC), active lane keep bouncing (ALKB), and the like are mainly performed in combination as appropriate. Accordingly, the vehicle M can travel along a target traveling route.

The adaptive cruise control is basically performed based on the traveling environment information input from the image recognition ECU 13 or the like.

Specifically, when no preceding vehicle is recognized ahead of the vehicle M by the image recognition ECU 13 or the like, the traveling ECU 14 performs constant speed traveling control as part of the adaptive cruise control. In the constant speed traveling control, the traveling ECU 14 performs acceleration/deceleration control on the vehicle M with the set vehicle speed input by the driver as a target vehicle speed. Accordingly, the traveling ECU 14 maintains the vehicle speed of the vehicle M at the set vehicle speed.

When a preceding vehicle is recognized ahead of the vehicle M by the image recognition ECU 13 or the like, the traveling ECU 14 performs follow-traveling control as part of the adaptive cruise control. In the follow-traveling control, the traveling ECU 14 sets a target inter-vehicle distance based on the vehicle speed of the preceding vehicle and the like and performs the acceleration/deceleration control for maintaining the target inter-vehicle distance.

The active lane keep centering and the active lane keep bouncing are basically performed based on the traveling environment information input from one or more of the image recognition ECU 13 and the locator unit 36. That is, the traveling ECU 14 sets a target traveling path along the right and left lane marking lines at the center of the vehicle traveling lane based on, for example, lane marking line information included in the traveling environment information. Then, the traveling ECU 14 maintains the vehicle M at the center of the lane by performing feed-forward control, feedback control, and the like for steering based on the target traveling path.

The second traveling control mode is a driving mode in which the vehicle M travels without requiring the steering wheel holding, the accelerator operation, and the brake operation by the driver. That is, the second traveling control mode is a so-called autonomous driving mode in which the vehicle M autonomously travels without requiring the driving operations by the driver. The second traveling control mode is realized by, for example, outputting various control signals to the E/G_ECU 22, the BK_ECU 24, and the PS_ECU 25 from the traveling ECU 14. In the second traveling control mode, preceding vehicle following control, active lane keep centering, active lane keep bouncing, and the like are mainly performed in combination as appropriate. Accordingly, the vehicle M can travel along a target route (according to route map information).

The limp home mode is a mode for automatically stopping the vehicle M at a side strip or the like. The limp home mode is performed, for example, when the vehicle traveling in the second traveling control mode cannot continue the traveling in this mode and the driver cannot take over the driving operation (i.e., the mode cannot be switched to the manual driving mode or the first traveling control mode).

In each of the above driving modes, the traveling ECU 14 can perform as appropriate autonomous emergency braking (AEB) (collision damage mitigation braking) or the like on an obstacle such as a vehicle having a strong possibility of colliding with the vehicle M.

The autonomous emergency braking is basically control for avoiding, by braking, a collision with an obstacle present ahead on the target traveling path of the vehicle M.

In the autonomous emergency braking, the traveling ECU 14 calculates, for example, a time to collision with an obstacle. Then, the traveling ECU 14 performs brake control in a stepwise manner based on a result of comparison between the time to collision and a preset threshold.

When the first traveling control mode or the second traveling control mode is selected, the traveling ECU 14 performs lane change control as necessary. In the lane change control, the traveling ECU 14 sets a target lateral position to, for example, the lane center of an adjacent lane. The traveling ECU 14 sets a target trajectory for moving the vehicle M to the target lateral position. Then, the traveling ECU 14 performs the lane change to the adjacent lane by performing steering control on the vehicle M along the target trajectory.

For example, the traveling ECU 14 performs the lane change control when the second traveling control mode is selected and determination is made that the lane change is necessary to cause the vehicle M to travel along the target route. For example, the traveling ECU 14 performs the lane change control when the first traveling control mode or the second traveling control mode is selected and the driver operates the direction indicator switch 31f. For example, the traveling ECU 14 performs the lane change control as appropriate when the first traveling control mode or the second traveling control mode is selected and the CP_ECU 21 starts automatic blinking of the direction indicator 30.

Further, the traveling ECU 14 performs right/left turn control as necessary when the first traveling control mode or the second traveling control mode is selected and an intersection is present ahead of the vehicle M. In the right/left turn control, for example, the traveling ECU 14 sets a target trajectory for causing the vehicle M to make a right turn or a left turn in the intersection. Then, the traveling ECU 14 makes a right turn or a left turn in the intersection by performing steering control on the vehicle M along the target trajectory.

For example, the traveling ECU 14 performs the right/left turn control when the second traveling control mode is selected and determination is made that a right or left turn is necessary to cause the vehicle M to travel along the target route. For example, the traveling ECU 14 performs the right/left turn control when the first traveling control mode or the second traveling control mode is selected and the driver operates the direction indicator switch 31f before the intersection. For example, the traveling ECU 14 performs the right/left turn control as appropriate when the first traveling control mode or the second traveling control mode is selected and the CP_ECU 21 starts automatic blinking of the direction indicator 30 before the intersection.

Next, the automatic blinking control on the direction indicator 30 of the vehicle M will be described in detail. In the present embodiment, the CP_ECU 21 performs the automatic blinking control on the direction indicator 30, for example, when the manual driving mode, the first traveling control mode, or the second traveling control mode is selected.

In the automatic blinking control, the CP_ECU 21 determines whether the current traveling state of the vehicle M is a traveling state in which a lane change or a right or left turn is recommended. This determination is made based on, for example, the traveling environment information. The lane change, the right or left turn, and the like correspond to steering that involves blinking of the direction indicator 30.

When determination is made that the traveling state of the vehicle M is a traveling state in which a lane change is recommended, the CP_ECU 21 guides the driver to change lanes.

The CP_ECU 21 monitors whether the driver has checked safety prior to the lane change within a set period (e.g., about 2 seconds) from the start of the lane change guidance. This monitoring is performed based on, for example, information on the line of sight of the driver detected by the DMS 31b. That is, the CP_ECU 21 monitors, for example, whether the driver has viewed a mirror viewing area A1 and a blind spot A2 in the direction in which the vehicle M is to change lanes. For example, as illustrated in FIG. 2, the mirror viewing area A1 refers to an area that can be viewed using a door mirror. The blind spot A2 refers to an area that cannot be viewed using the door mirror.

When determination is made that the driver has viewed the mirror viewing area A1 and the blind spot A2 in a predetermined manner within the set period, the CP_ECU 21 automatically blinks the direction indicator 30 in the direction in which the lane change is to be performed.

Similarly, when determination is made that the traveling state of the vehicle M is a traveling state in which a right or left turn is recommended, the CP_ECU 21 guides the driver to make a right or left turn.

The CP_ECU 21 monitors whether the driver has checked safety prior to the right or left turn within a set period (e.g., about 2 seconds) from the start of the right/left turn guidance. This monitoring is performed based on, for example, information on the line of sight of the driver detected by the DMS 31b.

When determination is made that the driver has viewed the mirror viewing area A1 and the blind spot A2 in a predetermined manner within the set period, the CP_ECU 21 automatically blinks the direction indicator 30 in the direction in which the right or left turn is to be made.

As described above, in the present embodiment, the CP_ECU 21 corresponds to a specific example of a steering guide and a blinking controller.

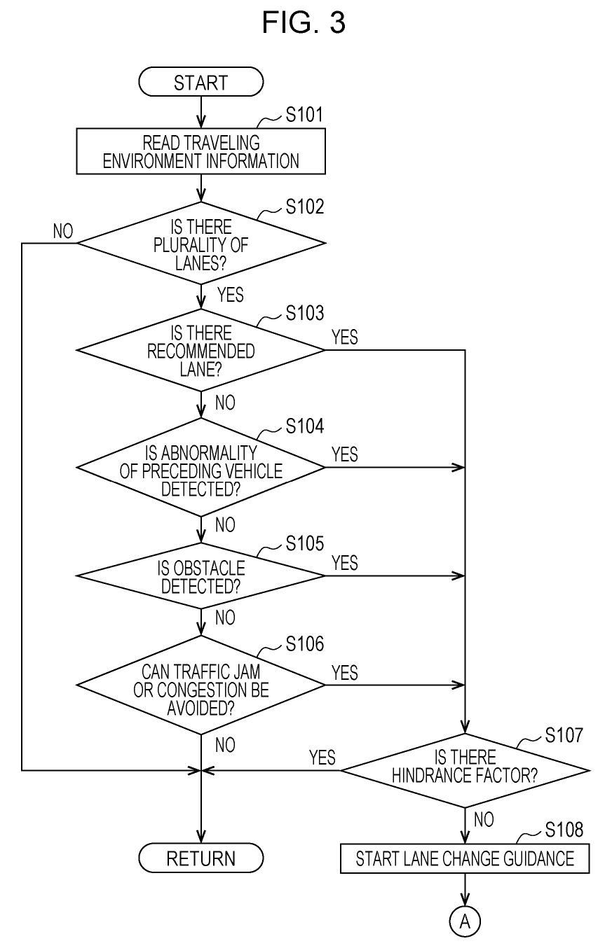

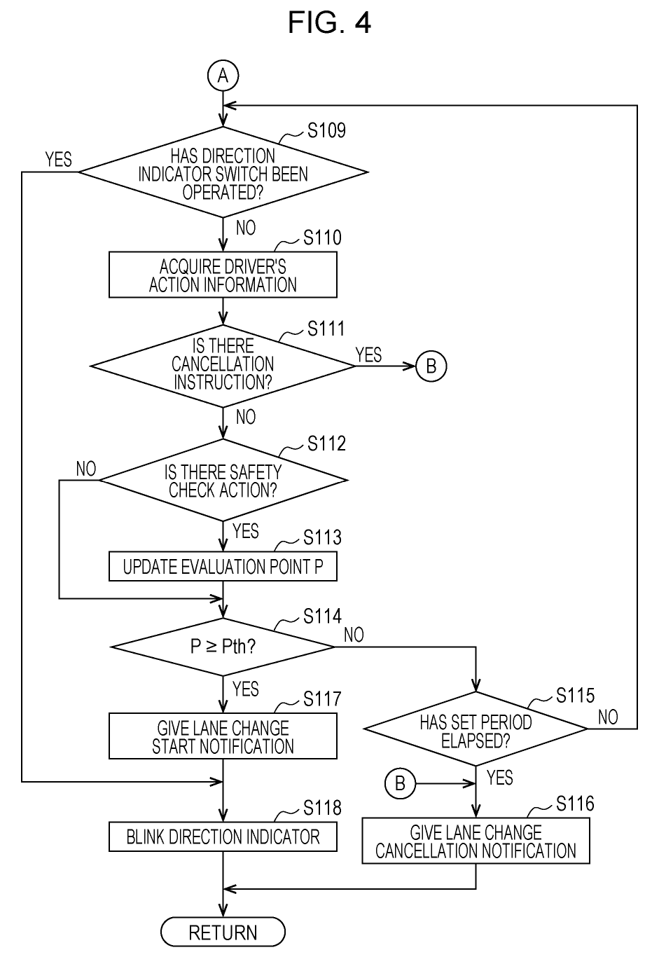

Next, the blinking control on the direction indicator 30 for a lane change of the vehicle M will be described with reference to flowcharts of a blinking control routine illustrated in FIG. 3 and FIG. 4. This routine is repeated at intervals of a set period by the CP_ECU 21.

When the routine is started, the CP_ECU 21 reads traveling environment information in step S101. That is, the CP_ECU 21 reads, for example, traveling environment information recognized by the image recognition ECU 13, traveling environment information recognized by the locator unit, and traveling environment information recognized by the sensors 37lf, 37rf, 37lr, and 37rr.

In step S102, the CP_ECU 21 checks whether the road where the vehicle M is traveling is a road having a plurality of lanes on each side.

When determination is made in step S102 that the road where the vehicle M is traveling is a road having one lane on each side (step S102: NO), the CP_ECU 21 terminates the routine. That is, when the vehicle M is traveling on a road having one lane on each side, the CP_ECU 21 terminates the routine because there is no need for the lane change.

When determination is made in step S102 that the road where the vehicle M is traveling is a road having a plurality of lanes on each side (step S102: YES), the CP_ECU 21 proceeds to step S103.

In step S103, the CP_ECU 21 checks whether there is a recommended lane for a lane change of the vehicle M. The recommended lane for a lane change of the vehicle M is, for example, a lane to which the lane change is desirably performed in advance to cause the vehicle M to efficiently travel toward the destination.

When determination is made in step S103 that there is a recommended lane for a lane change (step S103: YES), the CP_ECU 21 proceeds to step S107.

When determination is made in step S103 that there is no recommended lane for a lane change (step S103: NO), the CP_ECU 21 proceeds to step S104.

In step S104, the CP_ECU 21 checks whether an abnormality of a preceding vehicle is detected. For example, when the vehicle speed of a preceding vehicle traveling ahead of the vehicle M is extremely lower than the legal speed limit, the CP_ECU 21 determines that the preceding vehicle has an abnormality. For example, when a preceding vehicle traveling ahead of the vehicle M is meandering, the CP_ECU 21 determines that the preceding vehicle has an abnormality. For example, when luggage of a preceding vehicle traveling ahead of the vehicle M is unstable, the CP_ECU 21 determines that the preceding vehicle has an abnormality.

When the abnormality of the preceding vehicle is detected in step S104, the CP_ECU 21 proceeds to step S107.

When the abnormality of the preceding vehicle is not detected in step S104, the CP_ECU 21 proceeds to step S105.

In step S105, the CP_ECU 21 checks whether an obstacle is detected ahead of the vehicle traveling lane. For example, when a parked vehicle is present ahead of the vehicle traveling lane, the CP_ECU 21 determines that an obstacle is detected ahead of the vehicle traveling lane. For example, when the traffic is regulated in the forward area of the vehicle traveling lane due to construction, accident, or the like, the CP_ECU 21 determines that an obstacle is detected ahead of the vehicle traveling lane.

When determination is made in step S105 that an obstacle is detected (step S105: YES), the CP_ECU 21 proceeds to step S107.

When determination is made in step S105 that no obstacle is detected (step S105: NO), the CP_ECU 21 proceeds to step S106.

In step S106, the CP_ECU 21 checks whether a traffic jam or congestion can be avoided by a lane change. For example, when the traffic in the vehicle traveling lane is jammed or congested relatively more heavily than that in an adjacent lane, the CP_ECU 21 determines that the traffic jam or congestion can be avoided by the lane change.

When determination is made in step S106 that the traffic jam or congestion can be avoided by the lane change (step S106: YES), the CP_ECU 21 proceeds to step S107.

When determination is made in step S106 that the traffic jam or congestion cannot be avoided by the lane change (step S106: NO), the CP_ECU 21 terminates the routine.

When the process proceeds from step S103, S104, S105, or S106 to step S107, the CP_ECU 21 checks whether there is a factor that hinders the vehicle M from changing lanes. For example, when a vehicle traveling side by side is present in the lane to which the current lane is to be changed, the CP_ECU 21 determines that there is a factor that hinders the lane change. For example, when a succeeding vehicle traveling at a higher speed than the vehicle M is present in the lane to which the current lane is to be changed, the CP_ECU 21 determines that there is a factor that hinders the lane change.

When determination is made in step S107 that there is a hindrance factor (step S107: YES), the CP_ECU 21 terminates the routine.

When determination is made in step S107 that there is no hindrance factor (step S107: NO), the CP_ECU 21 proceeds to step S108.

In step S108, the CP_ECU 21 starts guiding the driver to change the lane to the adjacent lane. For example, the CP_ECU 21 uses the speaker 31e to notify the driver about a message such as "Lane change to the right lane is recommended. Please check safety of the right lane."

In step S109, the CP_ECU 21 checks whether the driver has operated the direction indicator switch 31f.

When determination is made in step S109 that the direction indicator switch 31f has been operated (step S109: YES), the CP_ECU 21 proceeds to step S118.

When determination is made in step S109 that the direction indicator switch 31f has not been operated (step S109: NO), the CP_ECU 21 proceeds to step S110.

In step S110, the CP_ECU 21 acquires driver's action information. For example, the CP_ECU 21 acquires information on the line of sight of the driver detected by the DMS 31b. The CP_ECU 21 acquires information on voice and sound of the driver detected by the microphone 31c. The CP_ECU 21 acquires information on the operation of the driver detected by the touch panel display device 31d.

In step S111, the CP_ECU 21 checks whether a cancellation instruction for the lane change has been given by the driver. For example, when the driver's vocal intention such as "I will not change lanes." is detected by the microphone 31c, the CP_ECU 21 determines that the cancellation instruction for the lane change has been given. Alternatively, when the driver expresses his/her intention not to perform the lane change by an operation input to the touch panel display device 31d, the CP_ECU 21 determines that the cancellation instruction for the lane change has been given.

When determination is made in step S111 that the cancellation instruction has been given by the driver (step S111: YES), the CP_ECU 21 proceeds to step S116.

When determination is made in step S111 that the cancellation instruction has not been given by the driver (step S111: NO), the CP_ECU 21 proceeds to step S112.

In step S112, the CP_ECU 21 checks whether the driver has performed a safety check action. In this case, the CP_ECU 21 makes determination based on, for example, whether the line of sight of the driver detected by the DMS 31b is directed to the mirror viewing area A1 or the blind spot A2 in the lane change direction.

When determination is made in step S112 that the safety check action has not been performed (step S112: NO), the CP_ECU 21 proceeds to step S114.

When determination is made in step S112 that the safety check action has been performed (step S112: YES), the CP_ECU 21 proceeds to step S113.

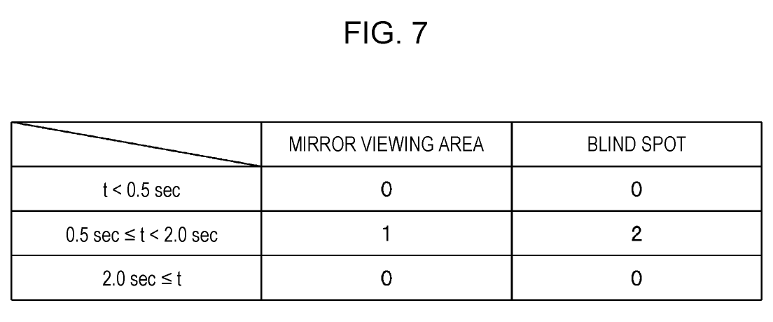

In step S113, the CP_ECU 21 updates an evaluation point P for the safety check performed by the driver. In this case, the safety check is evaluated based on, for example, a map illustrated in FIG. 7. As indicated in the map, the evaluation point P is added only when the driver takes an appropriate period to check safety at an appropriate timing after the start of the lane change guidance. That is, in the example illustrated in FIG. 7, the evaluation point P is not added when the driver checks safety at an excessively early timing or an excessively late timing after the start of the lane change guidance. The evaluation point is not added when the viewing action in the same direction is performed for less than a set period (e.g., less than 0.5 seconds). When the viewing action in the same direction continues for a set period or more (e.g., 1 second or more), it is desirable that the CP_ECU 21 determine that the line of sight of the driver has moved due to inattentive driving and do not add the evaluation point P.

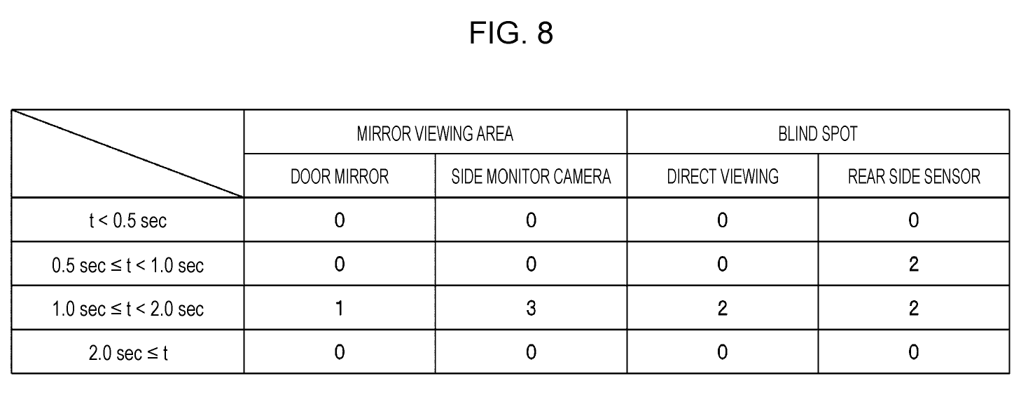

For example, in a vehicle with side monitor cameras or the like, the evaluation point for the mirror viewing area can be subdivided. When the left and right rear side sensors 37lr and 37rr are used for the safety check, the evaluation point for the blind spot can also be subdivided. In this case, the safety check can be evaluated using, for example, a map illustrated in FIG. 8. In this case, for example, the evaluation value in the case of viewing the mirror viewing area is different between the case of viewing the door mirror and the case of viewing an image captured by the side monitor camera. The evaluation value in the case of viewing the blind spot is different between the case of directly viewing the blind spot and the case of viewing information obtained by the left or right rear side sensor 37lr or 37rr.

When the process proceeds from step S112 or S113 to step S114, the CP_ECU 21 checks whether the evaluation point P for the safety check is equal to or more than a preset threshold Pth.

When determination is made in step S114 that the evaluation point P is equal to or more than the threshold Pth (step S114: YES), the CP_ECU 21 proceeds to step S117.

When determination is made in step S114 that the evaluation point P is less than the threshold Pth (step S114: NO), the CP_ECU 21 proceeds to step S115.

In step S115, the CP_ECU 21 checks whether a set period (e.g., 3 seconds) has elapsed from the start of the lane change guidance.

When determination is made in step S115 that the set period has not elapsed (step S115: NO), the CP_ECU 21 returns to step S109.

When determination is made in step S115 that the set period has elapsed (step S115: YES), the CP_ECU 21 proceeds to step S116.

When the process proceeds from step S111 or S115 to step S116, the CP_ECU 21 notifies the driver that the lane change is cancelled, and then terminates the routine. That is, the CP_ECU 21 notifies the driver that the lane change is cancelled by image display using the display device 31d, audio output using the speaker 31e, or the like.

When the process proceeds from step S114 to step S117, the CP_ECU 21 notifies the driver that the lane change is started, and then proceeds to step S118. That is, the CP_ECU 21 notifies the driver that the lane change is started by image display using the display device 31d, audio output using the speaker 31e, or the like.

When the process proceeds from step S109 or S117 to step S118, the CP_ECU 21 starts blinking the direction indicator 30 in the direction in which the vehicle M is to change lanes, and then terminates the routine.

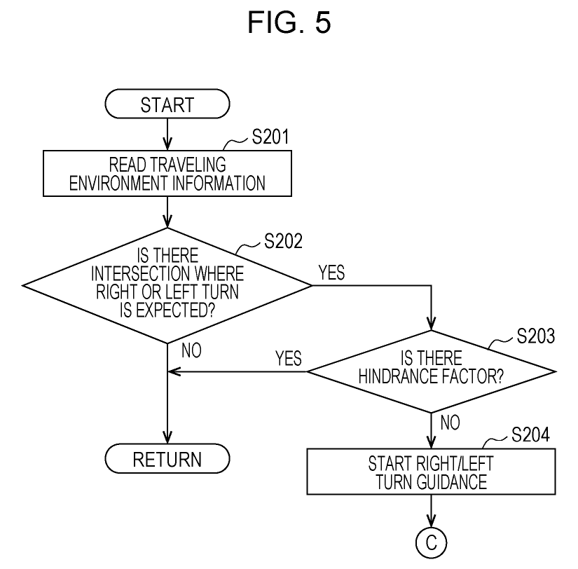

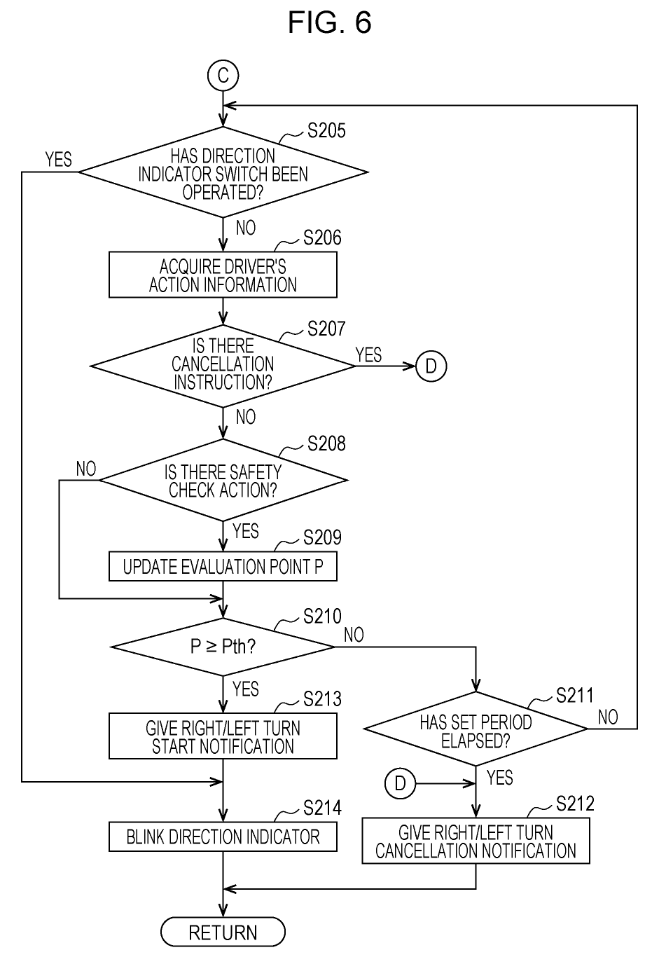

Next, the blinking control on the direction indicator 30 for a right or left turn of the vehicle M will be described with reference to flowcharts of a blinking control routine illustrated in FIG. 5 and FIG. 6. This routine is repeated at intervals of a set period by the CP_ECU 21.

When the routine is started, the CP_ECU 21 reads traveling environment information in step S201. That is, the CP_ECU 21 reads, for example, traveling environment information recognized by the image recognition ECU 13, traveling environment information recognized by the locator unit, and traveling environment information recognized by the sensors 37lf, 37rf, 37lr, and 37rr.

In step S202, the CP_ECU 21 checks whether an intersection where the vehicle M is expected to turn right or left is present within a set distance ahead of the vehicle M in the vehicle traveling lane.

When determination is made in step S202 that there is no intersection where the right or left turn is expected (step S202: NO), the CP_ECU 21 terminates the routine.

When determination is made in step S202 that there is an intersection where the right or left turn is expected (step S202: YES), the CP_ECU 21 proceeds to step S203.

In step S203, the CP_ECU 21 checks whether there is a factor that hinders the vehicle M from turning right or left. Examples of the hindrance factor include a case where the vehicle M is traveling in a lane where the vehicle M is expected to turn right (left) but cannot turn right (left).

When determination is made in step S203 that there is a hindrance factor (step S203: YES), the CP_ECU 21 terminates the routine.

When determination is made in step S203 that there is no hindrance factor (step S203: NO), the CP_ECU 21 starts guiding the vehicle to turn right or left. For example, the CP_ECU 21 uses the speaker 31e to notify the driver about a message such as "Right turn is recommended. Please check safety of the right lane."

The process of steps S205 to S214 is substantially the same as the process of steps S109 to S118. Therefore, specific description of the process will be omitted.

According to such an embodiment, the CP_ECU 21 guides the vehicle M to perform a lane change or a right or left turn (hereinafter referred to as "lane change or the like") based on the traveling environment information, and automatically blinks the direction indicator 30 when determination is made that the driver has checked the check region where the safety check is necessary for the lane change or the like before the set period elapses after the vehicle M is guided to perform the lane change. Thus, it is possible to automatically turn ON the direction indicator while ensuring safety and convenience for the driver.

That is, the CP_ECU 21 regards the predetermined safety check by the driver's viewing as an expression of the driver's intention of the lane change or the like. Therefore, the driver can automatically blink the direction indicator 30 without performing a complicated operation or the like. When the driver expresses his/her intention of the lane change or the like, the driver performs the predetermined safety check by viewing. Thus, safety can be ensured sufficiently. By automatically blinking the direction indicator 30 through the predetermined safety check by viewing, the direction indicator 30 can be blinked without omission at an appropriate timing in performing the lane change o the like.

In this case, not only the mirror viewing area A1 but also the blind spot A2 is set as the region for the safety check (check region) at the time of lane change or the like. Thus, the driver's intention of the lane change and the like can be made clearer, and the safety can further be improved when performing the lane change and the like.

In the above embodiment, each of the image recognition ECU 13, the traveling ECU 14, the CP_ECU 21, the E/G_ECU 22, the T/M_ECU 23, the BK_ECU 24, and the PS_ECU 25 is constituted by a known microcomputer including a CPU, a RAM, a ROM, a non-volatile storage unit, and the like, and peripheral devices thereof. The ROM prestores, for example, programs to be executed by the CPU and fixed data such as data tables. All or part of the functions of the processor may be implemented by a logic circuit or an analog circuit, and the processes of various programs may be implemented by an electronic circuit such as an FPGA.

The embodiment of the disclosure is not limited to the embodiment described above, and various modifications may be made without departing from the gist in the implementation. The embodiment includes various aspects of the disclosure that may be extracted by any appropriate combination of the disclosed constituent elements.

Some of the constituent elements in the embodiment may be omitted as long as the problems described above can be solved and the effects described above can be attained.

With the drive assist apparatus for the vehicle according to the embodiment of the disclosure, it is possible to automatically turn ON the direction indicator while ensuring safety and convenience for the driver.

The CP_ECU 21 illustrated in FIG. 1 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of the CP_ECU 21. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and a NVRAM. The ASIC is an integrated circuit (IC) customized to perform, and the FPGA is an integrated circuit designed to be configured after manufacturing in order to perform, all or a part of the functions of the modules illustrated in FIG. 1.

1. A drive assist apparatus for a vehicle, the drive assist apparatus comprising:
a traveling environment recognizer configured to recognize traveling environment information outside the vehicle;
a monitor configured to monitor a line of sight of a driver who drives the vehicle;
a steering guide configured to give guidance, based on the traveling environment information, on steering that involves blinking of a direction indicator of the vehicle;
and a blinking controller configured to automatically blink the direction indicator when determination is made that before a set period elapses after the guidance on the steering, the driver has viewed a check region where a safety check is necessary for the steering.

2. The drive assist apparatus for a vehicle according to claim 1, wherein the check region comprises a mirror viewing area that is viewable using an on-board mirror, and a blind spot that is not viewable using the on-board mirror, and
the blinking controller is configured to automatically
blink the direction indicator when determination is made that the driver has viewed the mirror viewing area and the blind spot.

3. The drive assist apparatus for a vehicle according to claim 2, wherein the mirror viewing area and the blind spot where the safety check is necessary are different depending on a direction of the steering.

4. A drive assist apparatus for a vehicle, the drive assist apparatus comprising:
a traveling environment recognition unit configured to recognize traveling environment information outside the vehicle;
a monitoring unit configured to monitor a line of sight of a driver who drives the vehicle; and
a processor, wherein the processor is configured to give guidance, based on the traveling environment information, on steering that involves blinking of a direction indicator of the vehicle, and
automatically blink the direction indicator when determination is made that before a set period elapses after the guidance on the steering, the driver has viewed a check region where a safety check is necessary for the steering.
